(19) United States
(12) Patent Application Publication
(10) Pub. No.: US 2024/0142087 A1
(43) Pub. Date: May 2, 2024

(54) LUMINAIRE

(71) Applicant: LEDLENSER GMBH & CO. KG, Solingen (DE)

(72) Inventor: Oliver DROSS, Hilden (DE)

(21) Appl. No.: 18/279,253

(22) PCT Filed: Feb. 3, 2022
(86) PCT No.: PCT/DE2022/100093

§ 371 Date: Aug. 29, 2023

(30) Foreign Application Priority Data
Apr. 22, 2021 (DE) 20 2021 102 154.3

(51) Int. Cl. F21V 13/02; F21V 5/00; F21V 23/04

(52) U.S. Cl. CPC F21V 13/02; F21V 5/007; F21V 23/04

(57) ABSTRACT

Luminaire with channels Kₙ, each have a light source and a collimator. Each channel produces a light cone having different opening angles. The channels form a sequence (Kₙ)_{n-1, . . . , N}, the light cones having progressively greater or smaller opening angles αₙ. The intensity lₙ(x) of the channels, controlled by a manipulated variable x by an actuator, are dependent on the manipulated variable and each follow a curve having a maximum and a rising edge and/or a falling edge. The curves of adjacent channels Kₙ₋₁, Kₙ, Kₙ₊₁ are shifted in relation to one another such that a reduction in the intensity of a channel, controlled by the actuator, is associated with an increase in the intensity of an adjacent channel K_{n±1} and an increase in intensity of a channel, controlled by the actuator, is associated with a reduction in intensity of an adjacent channel K_{n±1}.

### CROSS REFERENCE TO RELATED APPLICATIONS

This application is a United States National Phase Application of International Application PCT/DE2022/100093, filed Feb. 3, 2022, and claims the benefit of priority under 35 U.S.C. § 119 of German Application 20 2021 102 154.3, filed Apr. 22, 2021, the entire contents of which are incorporated herein by reference.

### TECHNICAL FIELD

The present invention pertains to a luminaire having a plurality of channels Kₙ, each having a light source and a collimator.

### BACKGROUND

Generic luminaires are usually designed as portable luminaires in the form of torches or headlamps. In order to be able to illuminate the area ahead at different distances by means of such luminaires, luminaires known according to the prior art have a mechanical zoom with which the distance between the light source and the collimator can be changed with the result that narrower or wider light distributions are produced depending on the setting. By means of a narrow light distribution—the spot beam—distant areas of the area ahead can be illuminated and by means of a wide light distribution—the flood beam—close areas of the area ahead can be illuminated.

Mechanical zooming is sometimes disadvantageous because it requires several parts to move in relation to each other, making it difficult to effectively seal a luminaire housing against dust and/or water ingress. Furthermore, a mechanical zoom requires a lot of space. The handling of a mechanical zoom is also disadvantageous, because it is not uncommon to need two hands for this and moving the components is only possible with a comparatively high amount of force due to possible jamming. Finally, the quality of the light distribution is moderate, because an optimal light distribution is always produced by a collimator only at a specific distance between light source and collimator. Zoom-related deviations from the optimal position therefore inevitably lead to suboptimal illumination of the area ahead.

### SUMMARY

An object of the present invention to propose a luminaire, in particular a portable luminaire in the form of a pocket lamp or headlamp, which remedies the aforementioned disadvantages. In particular, the aim is to create a zoomable luminaire that requires little space, is easy to seal, is easy to handle and produces an optimal light distribution independent of the zoom setting and therefore independent of the set width of the light distribution.

This object is achieved by the luminaire according to the invention. The following is provided according to the invention.

Each channel Kₙ produces a light cone having different opening angles αₙ. The opening angles αₙ of the light cones refer to the half-value width FWHM (full width at half maximum) of the light intensity emitted by the channels.

The channels Kₙ form a sequence (Kₙ)_{n-1, . . . , N}, the light cones of which have progressively greater or progressively smaller opening angles αₙ. In other words, the channels Kₙ are the consecutively numbered members of the sequence (Kₙ)_{n-1, . . . , N}, with index n and number N of channels. For N, N∈N therefore applies. The elements of the sequence (Kₙ)_{n-1, . . . , N} and thus the channels Kₙ are numbered in such a way that the opening angles of the light cones, starting from the first element/channel K₁ up to the last element/channel K_{N}, become either gradually greater or gradually smaller.

By setting a manipulated variable by means of an actuator, the intensity of the channels Kₙ can be controlled. This means that the intensity of the light produced by the light sources in the channels is controllable. The intensities of the channels are dependent on the manipulated variable and each follow a curve having a maximum as well as a rising edge and/or a falling edge, wherein the curves of adjacent channels Kₙ₋₁, Kₙ, K_{n±1} are shifted in relation to one another in such a way that
a) a reduction in the intensity of a channel Kₙ controlled by the actuator is at least partially associated with an increase in the intensity of an adjacent channel K_{n±1}, and
b) an increase in the intensity of a channel Kₙ controlled by the actuator is at least partially associated with a reduction in the intensity of an adjacent channel K_{n±1}.

In addition to a maximum, suitable curves have at least one rising edge or one falling edge. Independently of this, the curves can have both a rising edge and a falling edge in addition to a maximum. This allows a step-by-step increase or reduction of the emitted light cone without having to mechanically move the collimators in relation to the associated light sources. When the emitted light cone is gradually increased or reduced, a continuous increase or decrease in the intensity of the controlled channels is also created, resulting in a smooth transition between different zoom settings. The setting of the emitted light cone is thus completely electronic, which is why such a zoomable luminaire advantageously requires less space and is easy to seal and handle. Furthermore, the collimators can be optimally designed for the fixed distance to the respective assigned light source, such that an optimal light distribution results independent of the setting.

Preferred embodiments of the present invention are provided below and in the sub-claims.

Firstly, it is preferably provided that the manipulated variable-dependent intensities lₙ(x) each follow a bell-shaped curve with a rising edge, a maximum and a falling edge. The bell-shaped curve is open at the bottom.

In an advantageous development of the invention, it is provided that the maximum intensity of a channel Kₙ coincides with the end of the falling edge of the left-hand adjacent channel Kₙ₋₁ and with the beginning of the rising edge of the right-hand adjacent channel K_{n±1}. With such a shift, in particular with such a phase shift between the manipulated variable-dependent intensities, no further channel is controlled when the intensity of a channel Kₙ is at maximum. Only by changing the manipulated variable by means of the actuator is the intensity of the previously controlled channel Kₙ reduced, while the intensity of an adjacent channel K_{n±1} is increased until the actuator is also set here so that the adjacent channel K_{n±1} produces its maximum intensity. This results in a smooth zooming effect between different channels and a uniform light distribution, as only one or two channels are controlled, regardless of the setting, which is why the light distribution has a maximum of two areas with different light intensities.

According to a further advantageous development of the invention, it is provided that the intensities of the channels Kₙ are linear in the area of the rising edge and/or in the area of the falling edge. Preferably, it is provided that the intensities of the channels Kₙ between the beginning of the rising edge and the end of the falling edge follow a triangular function with a linear rising edge and a linear falling edge.

Alternatively, in a preferred embodiment of the invention, it is provided that the intensities of the channels Kₙ in the area of the rising edge and/or in the area of the falling edge follow a function in the form

lₙ(x)=sin^{a}(x+ϕₙ).

Here, x is the manipulated variable of the actuator. The constant a is an element of the real numbers and greater than or equal to 2, whereby the following applies: {a∈R|a≥2}. Finally, ϕₙ denotes the phase shift of the considered channel Kₙ. If both the rising edge and the falling edge follow the function lₙ(x)=sin^{a}(x+ϕn), there is a bell-shaped curve between the beginning of the rising edge and the end of the falling edge. However, the rising edge, the falling edge and/or the bell-shaped curve can also have any other shape, wherein the curve is preferably continuous and/or continuously differentiable.

According to a preferred embodiment of the invention, the actuator for setting the manipulated variable and thus for setting the intensity of the controlled channels Kₙ and for carrying out the electronically controlled zooming is an encoder, in particular a rotary encoder, a slide control or a push button. The manipulated variable is set by turning a knob in the case of a rotary encoder and by moving a slider in the case of a slide control. On the other hand, a push button can be set in such a way that continuous pressing of the push button results in a continuous change of the manipulated variable and thus in continuous zooming. Repeated pressing of the push button in this case can be associated with a stepwise change of the manipulated variable and thus the selected zoom setting. In addition to the actuators mentioned by way of example, all other conceivable devices for setting an actuating variable are also conceivable, in particular capacitive switches, motion controls in which an actuating variable is entered, for example, by a waving movement in front of the luminaire, or voice control.

According to a preferred embodiment of the invention, it is provided that the sequence (Kₙ)_{n-1, . . . , N} of the channels Kₙ is a finite sequence with a number of N channels Kₙ. This means that the control of the channels Kₙ takes place stepwise or continuously starting from the first channel K₁ to the last channel K_{N}, but that for a changeover from the channel K_{N} to the channel K₁, the sequence of channels Kₙ must be run through in reverse order. This embodiment is fulfilled, for example, if the actuator is designed as a slide control and the end stops of the slide control coincide with the channel K₁ on the left-hand side and with the channel K_{N} on the right-hand side.

Alternatively, it is provided that the sequence (Kₙ)_{n-1, . . . , N} of the channels Kₙ is a periodic sequence with a period length of the number N of the channels Kₙ such that the last channel K_{N} is an adjacent channel of the first channel K₁. Consequently: K_{N+1}=K₁. A periodic sequence of channels Kₙ can be realised, for example, by a rotary encoder or a push button, since neither a rotary encoder nor a push button is or has to be limited by a left-hand or right-hand stop.

Switching on the luminaire can be associated with different settings of the actuator. According to a first advantageous embodiment of the invention, it is provided that the switching on of the luminaire coincides with the last setting made of the actuator. Alternatively, it is provided that the switching on of the luminaire is associated with a constant start setting.

Finally, in a preferred embodiment of the invention, it is provided that the intensity of the channels outside the bell-shaped curve completely fades or assumes a constant value.

In the following, specific embodiments of the present invention are explained in more detail on the basis of the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic representation of a luminaire with three channels, and

FIG. 2a, FIG. 2b, FIG. 2c, FIG. 2d, FIG. 2e and FIG. 2f are diagrams with different progressions of the channel-dependent intensities as a function of a manipulated variable.

### DESCRIPTION OF PREFERRED EMBODIMENTS

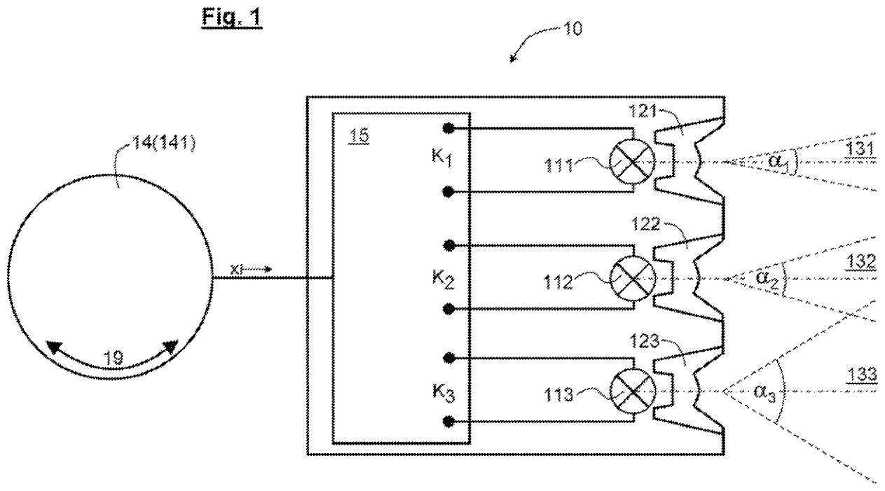

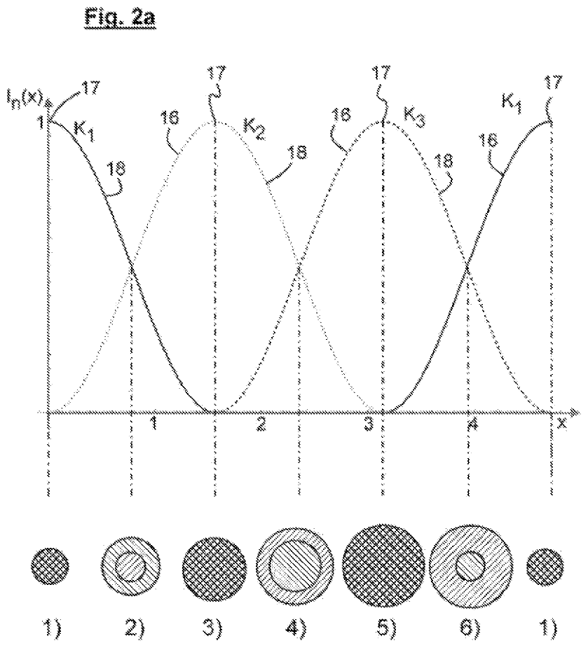

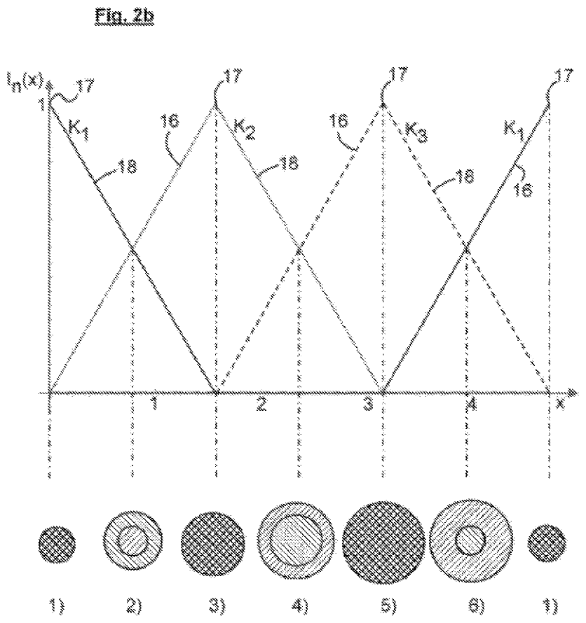

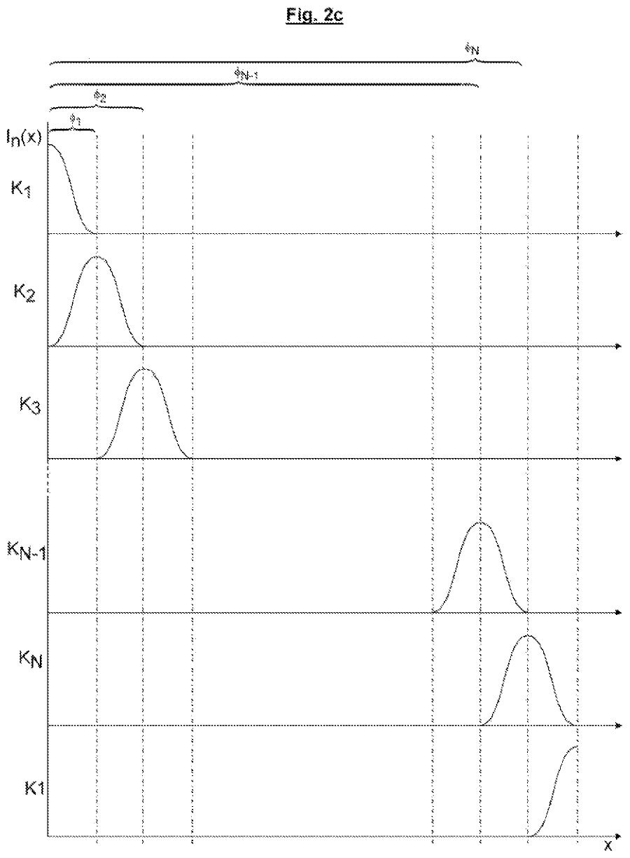

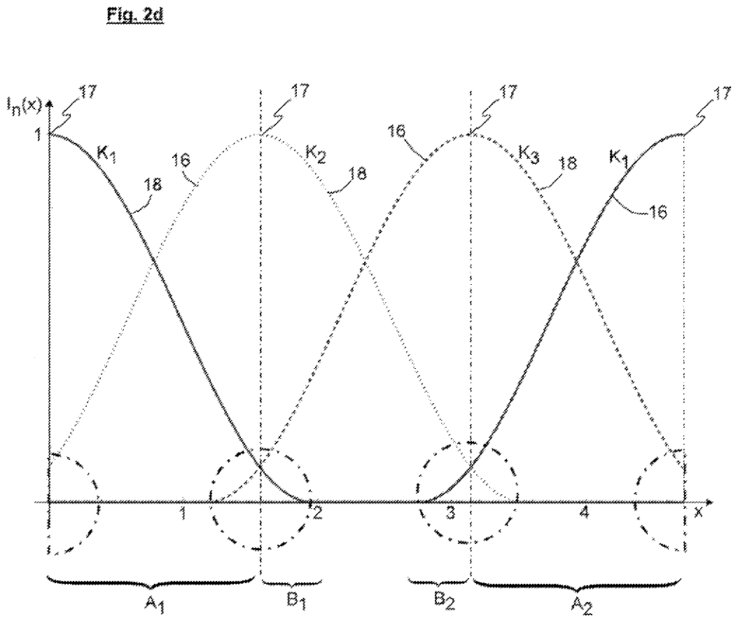

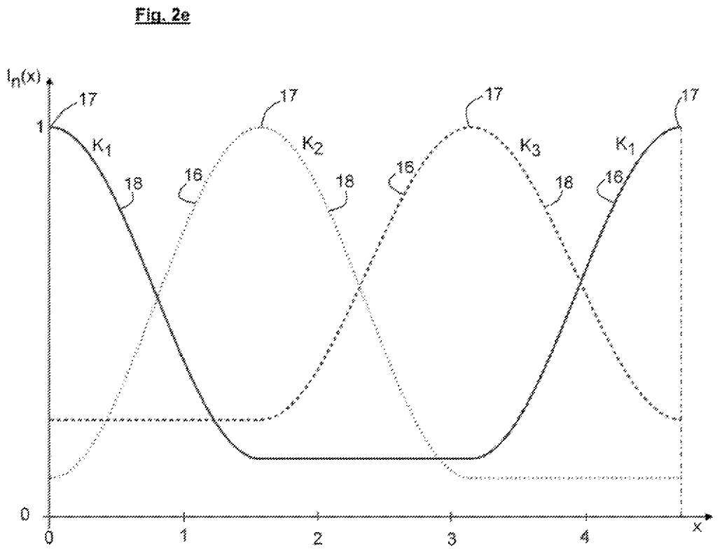

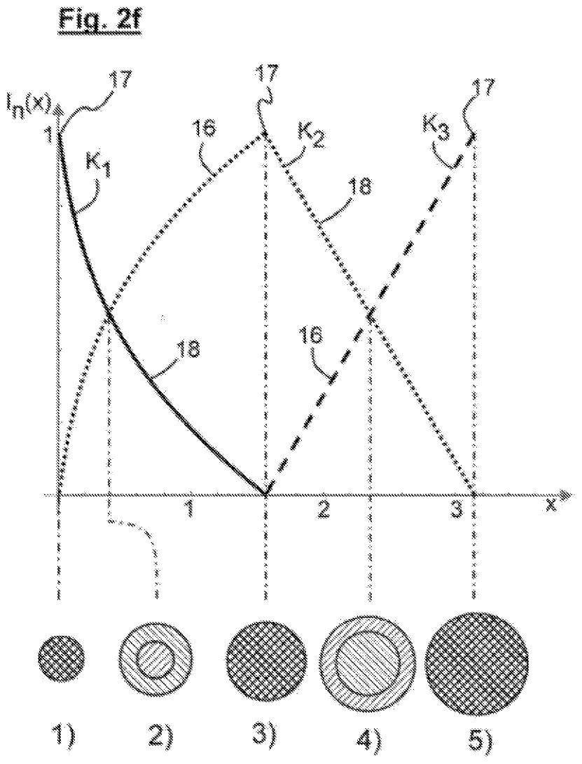

Referring to the drawings, FIG. 1 shows a schematic representation of a first embodiment of the invention. It shows a luminaire 10 with three channels K₁, K₂, K₃, which each have a light source 111, 112, 113 and a collimator 121, 122, 123. Each channel K₁, K₂, K₃, produces a light cone 131, 132, 133 with different opening angles α₁, α₂, α₃, wherein the channels K₁, K₂, K₃ form a sequence, the light cone 131, 132, 133 of which have a progressively greater opening angle α_{1,2,3}. Consequently: α₁<α₂<α₃. The intensities lₙ of the channels K₁, K₂, K₃ can be set by means of an actuator 14, wherein the actuator 14 in the exemplary embodiment shown is designed as a rotary encoder 141 and outputs a manipulated variable x to a control unit 15 as a function of its set rotational position. By rotating the actuator 14 in the arrow direction 19, the manipulated variable x changes and the channels K₁, K₂, K₃ produce a varying and manipulated variable-dependent intensity lₙ(x). The manipulated variable-dependent intensities lₙ(x) of the channels K₁, K₂, K₃ each follow a curve having a maximum as well as a rising edge and/or a falling edge, wherein the curves of adjacent channels Kₙ₋₁, Kₙ, Kₙ₊₁ are shifted in relation to one another in such a way that a reduction in the intensity lₙ(x) of a channel Kₙ controlled by the actuator 14 is at least partially associated with an increase in the intensity lₙ₊₁(x) of an adjacent channel K_{n±1} and vice versa. FIGS. 2a-e show different functional relationships of the channel-dependent intensities lₙ(x) as a function of a manipulated variable x.

FIG. 2a shows a first specific assignment of a manipulated variable x and the manipulated variable-dependent intensities lₙ(x) of the channels Kₙ, wherein the intensities lₙ(x) in FIG. 2a and in the following diagrams are shown in normalised form. According to this, the manipulated variable x=0 coincides with the maximum intensity lₙ(x) of the channel K₁, which in turn produces a light cone 131 with a comparatively small opening angle α₁ and thus a spot beam (position 1). The pictograms below the diagram in FIG. 2a show the cross-sectional views of the light cones 131, 132, 133 as viewed at a constant distance from the luminaire 10, wherein a cross-hatched cross-section symbolises a higher intensity and a diagonally hatched cross-section symbolises a comparatively lower intensity. By changing the manipulated variable x to larger values, the intensity l₁(x) of the channel K₁ initially decreases, while the intensity l₂(x) of the adjacent channel K₂ on the right simultaneously increases. The channel K₁ thus follows a falling edge 18, whereas the channel K₂ follows a rising edge 16. At the point of intersection (position 2), the result is a light distribution with a larger diameter compared to position 1. A further increase of the manipulated variable x up to position 3 leads to the maximum intensity l₂(x) of the channel K₂, while the other channels K₁, K₃ have a fading intensity l_{1,3}(x). Further increasing the manipulated variable x increases the diameter of the light distribution, as the channel K₃ is controlled with increasing intensity l₃(x). At position 4, a mixed light distribution results from channels K₂ and K₃, wherein the light cone has an opening angle α₃ that is greater compared to the opening angle α₂. A further increase of the manipulated variable x up to position 5 leads to a maximum intensity l₃(x) of the channel K₃ and thus to a homogeneous illumination of the area ahead with a maximum opening angle α₃, such that a flood beam is set in position 5. By further increasing the manipulated variable x, the intensity l₁(x) of the channel K₃ decreases and the intensity l₁(x) of the channel K₁ increases, because the channel K₁ in the exemplary embodiment shown is defined as a right-hand adjacent channel to the channel K₃. At position 6, the illumination of the channels K₃ and K₁ is weaker in intensity, which leads to the singular control of the channel K₁ when the manipulated variable x is increased further. Due to the shift or phase shift ϕn between the manipulated variable-dependent intensities lₙ(x) of the channels Kₙ, a continuous variation of the manipulated variable x allows a stepwise enlargement or reduction of the light cones 131, 132, 133. At the same time, the increase or decrease of the intensities lₙ(x) is continuous. This creates an electronically controlled zoom effect for optimal illumination of the area ahead.

The (normalised) intensities lₙ(x) according to FIG. 2a are in the form

lₙ(x)=sin²(x+ϕₙ),

wherein the phase shift ϕₙ is selected such that the maximum intensity of a channel Kₙ coincides with the end of the falling edge 18 of the left-hand adjacent channel Kₙ₋₁ and with the beginning of the rising edge 16 of the right-hand adjacent channel K_{n±1}. Deviating from this, FIG. 2b shows a triangular course of the intensities lₙ(x) with a linear rising edge 16, a maximum 17 and a linear falling edge 18. However, the mode of operation and thus the fading of the channels Kₙ by varying a predefinable manipulated variable x is analogous to the embodiment according to FIG. 2a.

Essentially, the number of channels Kₙ is unlimited. FIG. 2c shows the channel-dependent intensities lₙ(x) of the channels _{K1, . . . , N}, each with a phase shift ϕₙ, according with which the maximum intensity lₙ(x) of a channel Kₙ coincides with the end of the falling edge 18 of the left-hand adjacent channel Kₙ₋₁ and with the beginning of the rising edge 16 of the right-hand adjacent channel K_{n±1}.

The shift or phase shift ϕₙ between the channel-dependent intensities lₙ(x) can also be selected smaller in deviation from FIG. 2a, b, c such that a reduction in the intensity lₙ(x) of a channel Kₙ controlled by the actuator (14) is only partially associated with an increase in the intensity l_{n±1}(x) of an adjacent channel K_{n±1} and vice versa. FIG. 2d shows an exemplary embodiment of the invention with a comparatively smaller phase shift ϕₙ, such that the maxima 17 of the channels K₁, K₂, K₃ within the dashed circles coincide with a residual intensity of the adjacent channels K_{n±1}. A reduction of the intensity l₁(x) of the channel K₁ thus only leads to an increase of the intensity lₙ(x) of the adjacent channels K_{2,3} in the areas A₁ and A₂ and thus in sections. Outside of this, i.e. in areas B_{1, 2}, a reduction in the intensity l₁(x) of the channel K₁ also leads to a reduction in the intensity of a subsequent channel. Specifically, in the area B₁, if the intensity l₁(x) of the channel K₁ decreases, the intensity l₂(x) of the channel K₂ also decreases. In the area B₂, both the intensity l₁(x) of the channel K₁ and the intensity l₃(x) of the adjacent channel K₃ increase as the manipulated variable x increases.

Furthermore, within a specific embodiment of the invention, it is provided that the intensities lₙ(x) of the channels Kₙ do not fade outside the bell-shaped course, but have a constant value. FIG. 2e shows a corresponding curve of the channel-dependent intensities lₙ(x) as a function of the manipulated variable x. The basic intensity, i.e. the intensity lₙ(x) outside the bell-shaped area, can be identical or—as shown—different depending on the channel.

FIG. 2f shows a final exemplary assignment between a manipulated variable x and the manipulated variable-dependent intensities lₙ(x) of the channels Kₙ. According to this, the manipulated variable x=0 coincides with the maximum intensity l₁(x) of the channel K₁, which in turn produces a light cone 131 with a comparatively small opening angle α₁ and thus a spot beam (position 1). By changing the manipulated variable x to larger values, the intensity l₁(x) of the channel K₁ initially decreases, wherein the intensity k₁(x) follows a concave function, which means that the slope of the rising edge 16 becomes smaller as the manipulated variable x increases. Meanwhile, the intensity l₂(x) of the right-hand adjacent channel K₂ increases simultaneously, wherein the intensity l₂(x) follows a convex function, such that the slope of the descending edge 18 decreases as the manipulated variable x increases up to a maximum 17. At the point of intersection (position 2), the result is a light distribution with a larger diameter compared to position 1. A further increase of the manipulated variable x up to position 3 leads to the maximum intensity l₂(x) of the channel K₂, while the intensities l_{1,3}(x) of the other channels K₁, K₃ fade. Further increasing the manipulated variable x increases the diameter of the light distribution, as the channel K₃ is controlled with increasing intensity l₃(x). The intensity l₃(x) of the channel K₃ follows a form that is linearly dependent on the manipulated variable x, such that a linear rising edge is provided. At the same time, the intensity l₂(x) of the channel K₂ decreases, wherein the manipulated variable-dependent reduction of the intensity l₂(x) of the channel K₂ in this area also depends linearly on the manipulated variable x. Consequently, the channel K₂ has a linear falling edge 18. At position 4, a light cone is created with an opening angle α₃ that is greater compared to the opening angle α₂. A further increase of the manipulated variable x up to position 5 leads to a maximum intensity l₃(x) of the channel K₃ and thus to a homogeneous illumination of the area ahead with a maximum opening angle α₃, such that a flood beam is set in position 5. A mechanical and/or electronic stop of the encoder is provided at this point, such that no further increase of the manipulated variable x is provided. At least a further increase of the manipulated variable x does not lead to a change of the intensities lₙ(x) of the channel Kₙ controlled in this position. In the context of an electronic stop, a vibration signal, a visual signal, for example in the form of a brief flash, and/or an acoustic signal, for example in the form of a sound, is preferably emitted to signal to the user that the stop has been reached. If necessary, different signals can be used for the right-hand stop and the left-hand stop. A light distribution according to position 1, 2, 3 or 4 is thus only possible by turning back or pushing back the encoder. A corresponding stop is also provided on the left-hand side of position 1, which is why the manipulated variable x can only be varied between positions 1 and 5.

While specific embodiments of the invention have been shown and described in detail to illustrate the application of the principles of the invention, it will be understood that the invention may be embodied otherwise without departing from such principles.

### LIST OF REFERENCE NUMERALS

10 Luminaire
111 Light source
112 Light source
113 Light source
121 Collimator
122 Collimator
123 Collimator
131 Light cone
132 Light cone
133 Light cone
14 Actuator
141 Rotary encoder
15 Control unit
16 Rising edge
17 Maximum
18 Falling edge
19 Arrow direction
αₙ Opening angle (channel-dependent)
ϕₙ Phase shift (channel-dependent)
A_{1, 2} Area
B_{1, 2} Area
lₙ(x) Intensity (channel-dependent)
Kₙ Channel
n Index
N Number of channels
N Set of natural numbers
x Manipulated variable

1. A luminaire having a plurality of channels Kₙ, the channels each comprise a light source and a collimator, wherein
each channel Kₙ produces a light cone having different opening angles αₙ and
the channels Kₙ form a sequence (Kₙ)ₙ=1, . . . , _{N}, the light cones of which have progressively greater or progressively smaller opening angles αₙ and
an intensity lₙ(x) of the channels Kₙ can be controlled by a setting of a manipulated variable x by means of an actuator, wherein the intensities lₙ(x) of the channels Kₙ are dependent on the manipulated variable and each follow a curve having a maximum as well as a rising edge and/or a falling edge, wherein the curves of adjacent channels Kₙ−1, Kₙ, Kₙ+1 are shifted in relation to one another in such a way that
a reduction in the intensity lₙ(x) of a channel Kₙ controlled by the actuator is at least partially associated with an increase in the intensity lₙ±1(x) of an adjacent channel Kₙ±1, and
an increase in the intensity lₙ(x) of a channel Kₙ controlled by the actuator is at least partially associated with a reduction in the intensity lₙ±1(x) of an adjacent channel Kₙ±1.

2. The luminaire according to claim 1, wherein the manipulated variable-dependent intensities lₙ(x) each follow a bell-shaped curve with a rising edge, a maximum and a falling edge.

3. The luminaire according to claim 2, wherein the maximum intensity lₙ,max(x) of a channel Kₙ coincides with the end of the falling edge of a left-hand adjacent channel Kₙ₋₁ and with the beginning of the rising edge of a right-hand adjacent channel Kₙ₊₁.

4. The luminaire according to claim 2, wherein the intensities lₙ(x) of the channels Kₙ are linear in an area of the rising edge and/or in an area of the falling edge.

5. The luminaire according to claim 2, wherein the intensities lₙ(x) of the channels Kₙ in an area of the rising edge and/or in an area of the falling edge follow a function in a form lₙ(x)=sin^{a}(x+φₙ), with the manipulated variable x, {a∈R|a≥2} and the channel-dependent phase shift φₙ.

6. The luminaire according to claim 1, wherein the actuator is an encode.

7. The luminaire according to claim 1, characterised in that wherein the sequence (Kₙ)ₙ=1, . . . , _{N} of the channels Kₙ is a finite sequence with a number of N channels Kₙ.

8. The luminaire according to claim 1, wherein the sequence (Kₙ)ₙ=1, . . . , _{N} of the channels Kₙ is a periodic sequence with a period length of the number N of the channels Kₙ such that the last channel Kₙ is an adjacent channel of a first channel K₁.

9. The luminaire according to claim 1, wherein switching on of the luminaire coincides with the last setting made of the actuator.

10. The luminaire according to claim 2, wherein the intensities lₙ(x) of the channels Kₙ disappear completely outside the bell-shaped curve.

11. The luminaire according to claim 1, wherein the actuator is a rotary encoder.

12. The luminaire according to claim 1, wherein the actuator is a slide control.

13. The luminaire according to claim 1, wherein the actuator is a push button.

14. The luminaire according to claim 1, wherein switching on of the luminaire coincides with a constant start setting.

15. The luminaire according to claim 2, wherein the intensities of the channels assumes a constant value outside the bell-shaped curve.
